(19) United States
(12) Patent Application Publication
(10) Pub. No.: US 2024/0403801 A1
(43) Pub. Date: Dec. 5, 2024

(54) PREDICTING A DELIVERY TIME OF A PARCEL

(71) Applicant: AfterShip Pte. Ltd., Singapore (SG)

(72) Inventors: Lichun Liu, Shenzen (CN); Hao Pu, Shenzen (CN); Yusong Hu, Shenzen (CN); Guochun Li, Shenzen (CN); Yijin Ma, Shenzen (CN); Chuhai Lin, Shenzen (CN); Minzhi Luo, Shenzen (CN); Shan Gao, Shenzen (CN); Zhiwen Feng, Shenzen (CN)

(21) Appl. No.: 18/205,130

(22) Filed: Jun. 2, 2023

(51) Int. Cl. G06Q 10/083

(52) U.S. Cl. CPC G06Q 10/083

(57) ABSTRACT

Systems and methods for predicting a delivery time are provided. An example method includes: receiving one or more configurations for a merchant account associated with a merchant; providing to a machine-learning model parcel data corresponding to one or more products purchased from the merchant and the one or more configurations. The machine-learning model is trained based on historical parcel data, configurations, and delivery times to predict an estimated delivery time of one or more products. The method further includes receiving from the machine-learning model an estimated delivery time of the one or more products purchased from the merchant; obtaining updated parcel data corresponding to the one or more products; providing to the machine-learning model the updated parcel data to receive an updated estimated delivery time; and returning the updated estimated delivery time.

### BACKGROUND

Predicting a delivery time of a parcel helps to improve customer satisfaction and operational efficiency of a merchant and/or manufacturer. However, despite advances in the shipping services sector, inefficiencies in delivery and shipping continue to create significant issues for shippers, recipients, merchants, and carriers alike. One example challenge is accurately predicting transit time and delivery time for shipments which can be challenging for both senders and recipients, particularly after a parcel is already in transit. To address this need, there is a growing demand for innovative techniques that leverage merchant-provided shipping information, as well as dynamic updates to shipping timelines.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to methods, systems, and media for predicting a delivery time of a parcel.

In some examples, a method for predicting a delivery time is provided. The method includes: receiving one or more configurations for a merchant account associated with a merchant; and providing to a machine-learning model parcel data corresponding to one or more products purchased from the merchant and the one or more configurations. The machine-learning model is trained based on historical parcel data, configurations, and delivery times to predict an estimated delivery time of one or more products. The method further includes receiving from the machine-learning model an estimated delivery time of the one or more products purchased from the merchant; obtaining updated parcel data corresponding to the one or more products; providing to the machine-learning model the updated parcel data to receive an updated estimated delivery time; and returning the updated estimated delivery time.

In some examples, a system is provided. The system includes: a processor; and memory storing instructions that, when executed by the processor, cause the system to perform a set of operations. The set of operations include: generating a graphical user-interface (GUI); receiving, via the GUI, one or more configurations for a merchant account associated with a merchant; and providing to a machine-learning model parcel data corresponding to one or more products purchased from the merchant and the one or more configurations. The machine-learning model is trained based on historical parcel data, configurations, and delivery times to predict an estimated delivery time of one or more products. The set of operations further includes receiving from the machine-learning model an estimated delivery time of the one or more products purchased from the merchant; and dynamically updating the estimated delivery time of the one or more products.

In some examples, a method for predicting a delivery time is provided. The method includes: receiving parcel data corresponding to one or more products purchased from a merchant and an order processing time corresponding to the merchant; and providing to a machine-learning model the parcel data. The machine-learning model is trained based on historical parcel data and delivery times to predict an estimated delivery time of one or more products. The method further includes: determining, based on an output of the machine-learning model and the order processing time corresponding to the merchant, an estimated delivery time of the one or more products purchased from the merchant; obtaining updated parcel data corresponding to the one or more products; dynamically updating the estimated delivery time of the one or more products, thereby generating an updated estimated delivery time; and returning the updated estimated delivery time.

This summary is provided to introduce a selection of concepts in a simplified form that are further described below in the Detailed Description. This summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 illustrates an overview of an example system according to some aspects described herein.

FIG. 2 illustrates an example method for predicting a delivery time, according to some aspects described herein.

FIG. 3 illustrates an example method for predicting a delivery time, according to some aspects described herein.

FIG. 4 illustrates an example method for predicting a delivery time, according to some aspects described herein.

FIG. 5 illustrates an example user-interface, according to some aspects described herein.

FIG. 6 illustrates an example user-interface, according to some aspects described herein.

FIG. 7 illustrates an example user-interface, according to some aspects described herein.

FIG. 8 illustrates a block diagram illustrating example physical components of a computing device with which aspects of the disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As mentioned above, predicting a delivery time of a parcel helps to improve customer satisfaction and operational efficiency (e.g., of a merchant, manufacturer, and/or distributor). However, despite advances in the shipping services sector, inefficiencies in delivery and shipping continue to create significant issues for shippers, recipients, merchants, and carriers alike. One example challenge is accurately predicting transit times and delivery times for shipments which can be challenging for both senders and recipients, particularly after a parcel is already in transit.

There are more than 900 global couriers for which transportation levels, service types, and tracking data quality are significantly different, and it is difficult to ensure the prediction effect of all couriers. The transportation routes for the couriers involve many regions, with differing laws, policies, economies, and cultures. Transportation time spans through and/or across regions can be relatively large. Most of the time, parcels will pass through many regions, and weather, holidays, and other events of these areas have complex impacts on a delivery time of the parcels. Further, parcels involve many different industries and product categories, and their transportation methods and processing efficiencies may all differ. To address this these challenges, there is a growing demand for innovative techniques that leverage merchant-provided shipping information, as well as dynamic updates to shipping timelines, to accurately estimate delivery times.

Conventional systems and methods are often not capable of incorporating merchant processing times, such as for specific products or based on merchant shipping preferences, while also dynamically updating delivery times once a product is in transit. Conventional systems for estimating delivery time typically estimate delivery times before a parcel is in transit. However, such systems may fail to account for carrier errors, inclement weather, holidays, or other delivery disruptions which may once a parcel is already in transit. Further, conventional systems may consider processing times of carriers (such as how long it takes for a carrier to pick-up a parcel, or move a parcel from a received state to an in-transit state); however, such systems fail to consider a processing time of merchants. For example, merchants may have their own processing time for an order that are separate from the processing time of a carrier, and which occur after an order is placed for one or more products. The processing times for the merchant may differ with respect to specific products which a consumer can order.

Various examples of the present disclosure can achieve benefits and improvements over such conventional systems. For example, mechanisms provided herein may include receiving one or more configurations for a merchant account associated with a merchant. The merchant account may be configured based on the one or more configurations. The one or more configurations may include a processing time specific to the merchant that is associated with the merchant account. The processing time may be specific to one or more products purchased by a consumer. The one or more configurations may additionally and/or alternatively include selecting between a single estimated delivery time or a range of estimated delivery times, and selecting a preferred carrier and/or carrier service type. Such configurations enable mechanisms provided herein to be customized to specific merchants, and rely on the specific merchants' preferences to accurately estimate delivery times for one or more products.

The one or more configurations for the merchant account and parcel data specific to one or more ordered products purchased from a merchant may be provided to a machine-learning model that is trained based on historical parcel data, configurations, and delivery times to predict an estimated delivery time of one or more products. The machine-learning model may output an estimated delivery time of the one or more products purchased from the merchant. Updated parcel data may then be received and used to dynamically update the estimated delivery time of the one or more products. For example, the updated parcel data may be provided to the machine-learning model to output an updated estimated delivery time.

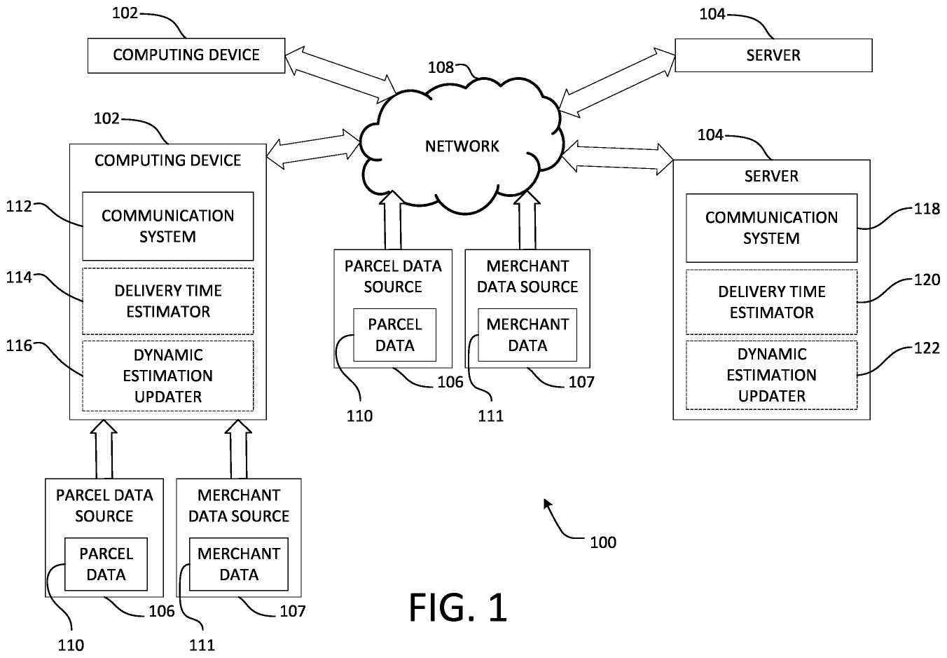

FIG. 1 shows an example of a system 100, in accordance with some aspects of the disclosed subject matter. The system 100 may be a system for predicting a delivery time, such as a delivery time of one or more products from a merchant. The system 100 includes one or more computing devices 102, one or more servers 104, one or more parcel data sources 106, one or more merchant data sources 107, and a communication network or network 108.

In some examples, the computing device 102 can receive parcel data 110 from the parcel data source 106. Additionally, or alternatively, in some examples, the network 108 can receive parcel data 110 from the parcel data source 106. In some examples, the computing device 102 can receive merchant data 111 from the merchant data source 107. Additionally, or alternatively, in some examples, the network 108 can receive merchant data 111 form the merchant data source 107.

In some examples, computing device 102 includes a communication system 112, delivery time estimator 114, and/or a dynamic estimation updater 116. In some embodiments, computing device 102 can execute at least a portion of the delivery time estimator 114 to estimate a delivery time of one or more parcels based on the parcel data 110 and/or the merchant data 107. In some examples, the computing device 102 can execute at least a portion of the dynamic estimation updater 116 to dynamically update a previously-estimated delivery time, such as based on updated parcel data 110.

In some examples, server 104 includes a communication system 118, delivery time estimator 120, and/or a dynamic estimation updater 122. In some embodiments, server 104 can execute at least a portion of the delivery time estimator 120 to estimate a delivery time of one or more parcels based on the parcel data 110 and/or the merchant data 107. In some examples, the server 104 can execute at least a portion of the dynamic estimation updater 122 to dynamically update a previously-estimated delivery time, such as based on updated parcel data 110.

Additionally, or alternatively, in some examples, computing device 102 can communicate data received from parcel data source 106 and/or the merchant data source 107 to the server 104 over a communication network 108, which can execute at least a portion of the delivery time estimator 114, 120 and/or the dynamic estimation updater 116, 122. In some examples, the delivery time estimator 114, 120 executes one or more portions of methods/processes disclosed herein and/or recognized by those of ordinary skill in the art, in light of the present disclosure. In some examples, the dynamic estimation updater 116, 122 executes one or more portions of methods/processes disclosed herein and/or recognized by those of ordinary skill in the art, in light of the present disclosure.

In some examples, computing device 102 and/or server 104 can be any suitable computing device or combination of devices, such as a desktop computer, a mobile computing device (e.g., a laptop computer, a smartphone, a tablet computer, a wearable computer, etc.), a server computer, a virtual machine being executed by a physical computing device, a web server, etc. Further, in some examples, there may be a plurality of computing device 102 and/or a plurality of servers 104.

In some example, parcel data source 106 can be any suitable source of parcel data (e.g., data generated from a computing device, data stored in a repository, data generated from a software application, etc.). In some examples, parcel data source 106 can include memory storing parcel data (e.g., local memory of computing device 102, local memory of server 104, cloud storage, probable memory connected to computing device 102, portable memory connected to server 104, etc.). In some examples, parcel data source 106 can include an application configured to generate parcel data and prove the parcel data via a software interface. In some examples, parcel data source can be local to computing device 102. In some examples, parcel data source 106 can be remote from computing device 102, and can communicate parcel data 110 to computing device 102 (and/or server 104) via a communication network (e.g., communication network 108). In some examples, the parcel data source 106 may include multiple sources of parcel data. In some examples, the parcel data source 106 may be associated with one or more carriers. In some examples, the parcel data source 106 may be associated with one or more users.

In some examples, the parcel data 110 includes a tracking number and/or information receivable from a tracking number. In some examples, the parcel data 110 includes a carrier-provided delivery estimate, a carrier processing/handling time, a carrier name, a carrier service type (e.g., air, ground, expedited, normal, etc.), a tracking history, a status update, a current location, an origination location, a delivery location, one or more checkpoint locations, etc. In some examples, the parcel data 110 includes one or more products, a merchant from which the one or more products were ordered, a weight of the one or more products, etc. Additional and/or alternatives attributes of parcel data 110 may be recognized by those of ordinary skill in the art, at least in light of teachings provided herein.

In some example, merchant data source 107 can be any suitable source of merchant data (e.g., data generated from a computing device, data stored in a repository, data generated from a software application, etc.). In some examples, merchant data source 107 can include memory storing merchant data (e.g., local memory of computing device 102, local memory of server 104, cloud storage, probable memory connected to computing device 102, portable memory connected to server 104, etc.). In some examples, merchant data source 107 can include an application configured to generate merchant data and prove the merchant data via a software interface. In some examples, merchant data source can be local to computing device 102. In some examples, merchant data source 107 can be remote from computing device 102, and can communicate merchant data 111 to computing device 102 (and/or server 104) via a communication network (e.g., communication network 108). In some examples, the merchant data source 107 may include multiple sources of merchant data.

In some examples, the merchant data 111 includes configurations of a merchant account associated with a specific merchant. In some examples, the merchant data 111 includes an order processing time provided by a merchant. In some examples, the order processing time may vary depending on specific products that are ordered from the merchant. In some examples, the merchant data 111 includes preferences for providing one of a single estimated delivery time and/or a configurable range of estimated delivery times. In some examples, the merchant data 111 includes special shipping rules (e.g., preferred carriers or service types) specific to one or more merchants. In some examples, the merchant data 111 includes shipping rules designated by merchants which are dependent upon a recipient's location. Additional and/or alternative attributes of the merchant data 111 may be recognized by those of ordinary skill in the art, at least in light of teachings provided herein.

In some examples, communication network 108 can be any suitable communication network or combination of communication networks. For example, communication network 108 can include a Wi-Fi network (which can include one or more wireless routers, one or more switches, etc.), a peer-to-peer network (e.g., a Bluetooth or Bluetooth Low Energy network), a cellular network (e.g., a 3G network, a 4G network, a 5G network, etc., complying with any suitable standard), a wired network, etc. In some examples, communication network 108 can be a local area network (LAN), interfaces conforming known communications standard, such as Bluetooth® standard, IEEE 802 standards (e.g., IEEE 802.11), a ZigBee® or similar specification, such as those based on the IEEE 802.15.4 standard, a wide area network (WAN), a public network (e.g., the Internet), a private or semi-private network (e.g., a corporate or university intranet), any other suitable type of network, or any suitable combination of networks. In some examples, communication links (arrows) shown in FIG. 1 can each be any suitable communications link or combination of communication links, such as wired links, fiber optics links, Wi-Fi links, Bluetooth® links, cellular links, satellite links, etc.

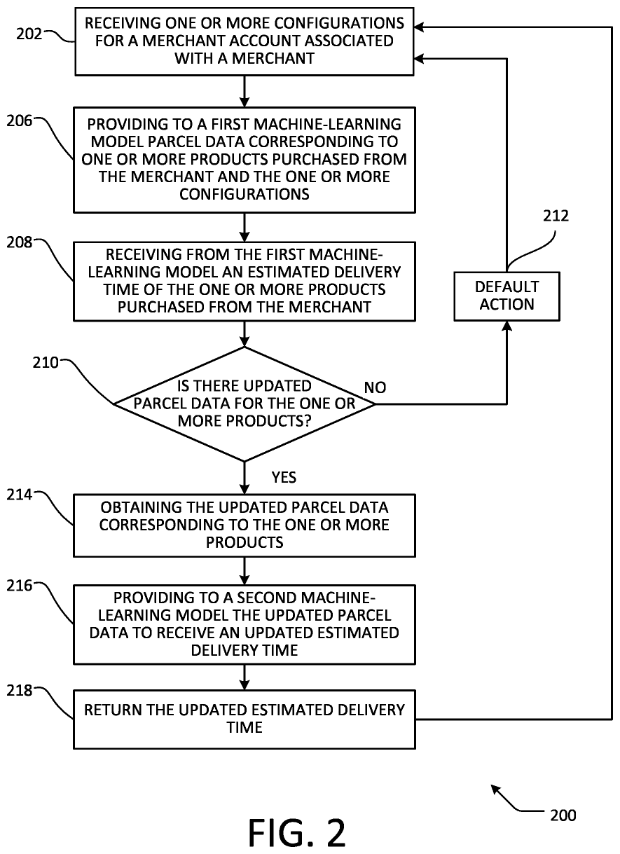

FIG. 2 illustrate an example method 200, according to some aspects described herein. The example method 200 may be a method for predicting a delivery time. In examples, aspects of method 200 are performed by a device, such as computing device 102 and/or server 104, discussed above with respect to FIG. 1.

Method 200 begins at operation 202, wherein one or more configurations for a merchant account are received. The merchant account is associated with a merchant. The one or more configurations may be settings or options that are input by an agent, such as a human or system, for particular use cases. For example, the method 200 may include generating a user-interface, such as a graphical user-interface (GUI), and receiving via the user-interface, the one or more configurations for the merchant account. The user-interface may include a touchscreen, microphone, speaker, dial, buttons, sliders, camera, mouse, keyboard, or other input mechanisms that will be recognized by those of ordinary skill in the art to receive input from a user.

In some examples, the one or more configurations for the merchant account include a processing time specific to the merchant that is associated with the merchant account. For example, some merchants may take one day to process (e.g., locate, create, move, package, transfer to a carrier, etc.) one or more products for a carrier to deliver, while other merchants may take two days, or three days, or four days, or any other number amount of time to process one or more products for a carrier to deliver. In some examples, the order processing time is how long a warehouse needs to process an order (e.g., in a number of business days). In some examples, the one or more configurations may include which days in a week are business days. In some examples, holidays are automatically excluded from business days and therefore add an extra day to how long is needed to process an order.

In some examples, the processing time is specific to the purchased one or more products. For example, a first product may have a first processing time that is less than the processing time of a second product. The first product and the second product may have different labels, stock keeping units (SKUs), sizes, colors, weights, or otherwise be differentiable from each other. Therefore, the one or more configurations may include entries and/or selections that correspond to processing times specific to particular products. In some examples, there may be a database or repository of processing times that are each associated with certain products, such that when a particular product is selected, a corresponding processing time associated with the merchant can be obtained.

In some examples, the one or more configurations for the merchant account comprise a selection between providing one of a single estimated delivery time or a range of estimated delivery times. For providing a range of estimated delivery times, a tolerance may be set as to how wide is the range. Some merchants may prefer to select a single estimated delivery time (e.g., a specific date or a time on a specific date). However, some merchants may prefer to provide a range of estimated delivery times (e.g., range of dates and/or times on dates), such as to improve user experience by reducing frustration of a customer in the event that the single time was incorrect.

In some examples, the one or more configurations for the merchant account include a preferred carrier and/or carrier service type. The preferred carrier may be any one of a plurality of carriers that may be recognize by those of ordinary skill in the art, such as companies or organizations that provide transportation for the movement of goods. Carrier service types may include air (e.g., airplanes, drones, etc.) water (e.g., ships, water skis, boats, etc.) ground (e.g., trucks, cars, trains, bicycle, etc.). Additional and/or alternative carrier service types or examples thereof will be recognized by those of ordinary skill in the art.

Receiving configurations for a merchant account is advantageous to enable mechanisms provided herein to provide accurate delivery estimates, such as for customers, carriers, distributors, or others. Further, collecting configurations for merchant accounts can be useful for aggregating data to calculate processing time metrics at scale (e.g., as may be beneficial for organizing inventory and/or warehouse logistics).

In some examples, the merchant account is configured based on the one or more configurations. Information associated with the merchant account may be stored local to a computing device (e.g., computing device 102) and/or remote from a computing device (e.g., on server 104). Accordingly, the configuring of the merchant account may include updating data stored in memory that is associated with the merchant account. When performing further processing, such as calculating a delivery time, the data stored in memory associated with the merchant account may be referenced by a processor to extract information applicable to the calculation of the delivery time.

At operation 206, parcel data is provided to a first machine-learning model. The parcel data corresponds to one or more products purchased from the merchant. The one or more configurations and/or an indication thereof may also be provided to the first machine-learning model. The first machine-learning model may be trained based on historical parcel data, historical configurations, and historical delivery times to predict an estimated delivery time of one or more products.

The parcel data may be similar and/or the same as the parcel data 110 discussed earlier herein with respect to FIG. 1. For example, the parcel data may include a tracking number and/or information receivable from a tracking number. In some examples, the parcel data includes a carrier-provided delivery estimate, a carrier processing/handling time, a carrier name, a carrier service type (e.g., air, ground, expedited, normal, etc.), a tracking history, a status update, a current location, an origination location, a delivery location, one or more checkpoint locations, etc. In some examples, the parcel data includes an identifier of one or more products, a merchant from which the one or more products were ordered, a weight of the one or more products, etc. Additional and/or alternatives attributes of parcel data may be recognized by those of ordinary skill in the art, at least in light of teachings provided herein.

The historical parcel data, configurations, and delivery times may be aggregated from data collected by carriers and/or merchants. For example, the historical parcel data, configurations, and/or delivery times may be aggregated from calls to APIs and/or data stores associated with individual merchants/carriers. In some examples, the historical parcel data and delivery times may be aggregated from more than 1,300 carriers in different countries around the world. In some examples, the historical parcel data, configurations, and/or delivery times may be otherwise obtained and uploaded to a data store on which the first machine-learning model may be trained.

The historical parcel data, configurations, and/or delivery times may be normalized, processed, and/or cleaned, as needed, to improve training of first the machine-learning model. For example, mechanisms provided herein may include address parsers that can parse an address from text to structured data. Further, mechanisms provided herein may include auto-detect which can recognize carriers according to tracking numbers. With these functionalities, mechanisms provided herein may be able to provide-high-quality training data, which helps to improve performance of machine-learning models trained thereon.

In some examples, data attributes that are used to train the first machine-learning model may include the name of a carrier, the type of service used by the carrier (e.g., air, ground, expedited, water), whether the origin and destination of the one or more products beings delivered belong to the same country, whether the origin and destination of the one or more products being delivered belong to the same state, whether the origin and destination of the one or more products being delivered belong to the same city, the raw address of the origin of the one or more products, the raw address of the destination of the one or more products, the weekday of the one or more package's pickup time, the time of day of the one or more package's pickup time, the sequence of holidays of the origin on the pickup day and the next 7 days, the raw address at a checkpoint of the one or more products while in transit, a message associated with the checkpoint, the number of days between pickup time and checkpoint time, and a number of checkpoints. In some examples, the raw addresses (e.g., of origins, destinations) may be converted to coordinates (e.g., including latitude and longitude).

In some examples, the first machine-learning model includes one or more neural networks. In some examples, the first machine-learning model includes one or more deep learning models that are trained using deep learning techniques to improve accuracy of predictions. In some examples, the first machine-learning model includes one or more regressive neural networks (RNNs) and/or one or more convolutional neural networks (CNNs).

In some examples, encoding methods are used to transform data inputs into real number vectors. The first machine-learning model will learn the weights of the data inputs according to a distribution of the data inputs, automatically.

At operation 208, an estimated delivery time of the one or more products purchased from the merchant is received from the first machine-learning model. The estimated delivery time may be provided as an output. Additionally, or alternatively, an indication of the estimated delivery time may be generated for insertion into a virtual page (e.g., a web page, a mobile application page, a desktop application page). In some examples, a widget is generated that includes the indication of the estimated delivery time and the widget is inserted into the virtual page.

In some examples, a message is generated that includes the estimated delivery time or an indication thereof. The message may be sent (e.g., via email, message, telephone, notification, etc.). The message may be sent to a customer, such as a customer who purchased the one or more products being delivered. Additionally, or alternatively, the message may be sent to a warehouse, or another entity with an interest in the delivery of the one or more products.

At operation 210, it is determined if there is updated parcel data for the one or more products. For example, updated parcel data may be received from a carrier service and/or provided by a user. The updated parcel data may correspond to a checkpoint of a parcel while it is in transit to its destination. It may be determined if there is updated parcel data by polling an application programming interface (API) associated with a carrier service and/or by determining if a checkpoint exists for the one or more products in transit.

If there is not updated parcel data for the one or more products, then flow branches “NO” to operation 212, where a default action is performed. For example, the parcel data and/or merchant account may include a pre-configured action that is performed at operation 212. In some examples, method 200 may comprise determining whether the parcel data and/or merchant account has an associated default action, such that, in some instances, no action may be performed as a result of determining that no updated parcel data has been received. Method 200 may terminate at operation 212. Alternatively, method 200 may return to operation 202 to provide an iterative loop of configuring a merchant account, calculating an estimated delivery time of one or more products, and determining whether updated parcel data for the one or more products is obtainable.

However, if it is determined that there is updated parcel data for the one or more products, then flow branches “YES”, wherein method 200 advances to operation 214. At operation 214, the updated parcel data is obtained. The updated parcel data may have similar attributes as discussed with respect to the parcel data of operation 206. The updated parcel data may be obtained while the one or more products are in transit to be delivered (e.g., after the one or more products have already left their origin, but before they have arrived at their destination). The updated parcel data corresponds to the one or more products (e.g., one or more parcels containing the one or more products).

The updated parcel data may include a message of a checkpoint corresponding to a parcel being on time or delayed. For example, the checkpoint message may include: “currently awaiting shipment and tracking will be updated when received,” or “experiencing delay due to inclement weather, tracking will be updated when in transit.” Checkpoint messages may indicate that a parcel containing the one or more packages is on-time, delayed, or that the current status of the parcel is unknown but that an update will be provided shortly. In some examples, parcels may be delayed due to holidays, power-outages, inclement weather, protests, traffic, pandemics, floods, gas leaks, customs clearance, or other circumstances which those of ordinary skill in the art will recognize may delay the delivery of parcels. In some instances, the checkpoint messages may indicate for how long a parcel is delayed. In some instances, mechanisms provided herein may product for how long the parcel is delayed based on the checkpoint message that is provided and historical parcel data on which the machine-learning model is trained.

At operation 216, the updated parcel data is provided to a second machine-learning model (e.g., a different machine-learning model than the first machine-learning model of operation 206) to receive an updated estimated delivery time. For example, the updated estimated delivery time may be determined by the second machine-learning model based on (and/or at least in part on) the updated parcel data. In some examples, the second machine-learning model may be trained in a similar manner as discussed above with respect to the first machine-learning model.

At operation 218, the updated estimated delivery time is returned. The updated estimated delivery time may be provided as an output. Additionally, or alternatively, an indication of the updated estimated delivery time may be generated for insertion into a virtual page (e.g., a web page, a mobile application page, a desktop application page). In some examples, a widget is generated that includes the indication of the updated estimated delivery time and the widget is inserted into the virtual page. In some examples, the updated estimated delivery time (or an indication thereof) replaces the estimated delivery time (or an indication thereof) on the virtual page.

In some examples, a message is generated that includes the updated estimated delivery time or an indication thereof. The message may be sent (e.g., via email, message, telephone, notification, etc.). The message may be sent to a customer, such as a customer who purchased the one or more products being delivered. Additionally, or alternatively, the message may be sent to a warehouse, or another entity with an interest in the delivery of the one or more products.

Generally, updating the estimated delivery time provides the ability to dynamically alter the delivery time of one or more products (e.g., while they are in transit), based on up-to-date information, thus enabling accuracy in predicting the delivery time of the one or more products. Indications of events that lead to the dynamic updating may be extracted automatically from checkpoint messages and real-time locations of the one or more products.

Method 200 may terminate at operation 216. Alternatively, method 200 may return to operation 202 (or any other operation from method 200) to provide an iterative loop, such as of configuring a merchant account, calculating an estimated delivery time based on the configurations of the merchant account and parcel data, and dynamically updating the estimated delivery time based on updated parcel data.

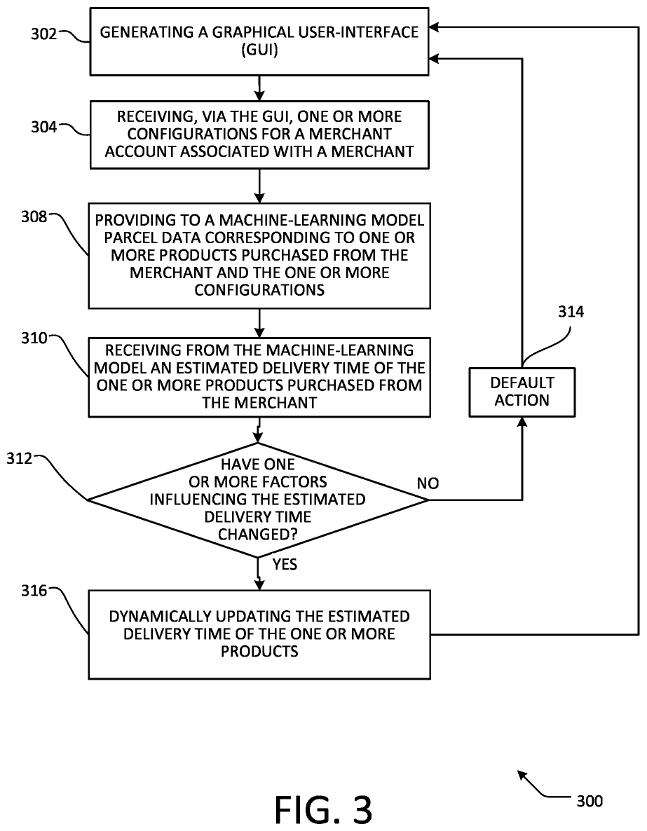

FIG. 3 illustrate an example method 300, according to some aspects described herein. The example method 300 may be a method for predicting a delivery time. In examples, aspects of method 300 are performed by a device, such as computing device 102 and/or server 104, discussed above with respect to FIG. 1.

Method 300 begins at operation 302, wherein a graphical user-interface (GUI) is generated. The GUI may be generated on the display screen of a computing device, such as of the computing device 102. The computing device on which the GUI is displayed may include a touchscreen, microphone, speaker, dial, buttons, sliders, camera, mouse, keyboard, or other input mechanisms that will be recognized by those of ordinary skill in the art to receive input from a user. Accordingly, a user may interact with the GUI using any one of the plurality of input mechanisms disclosed herein or known to those of ordinary skill in the art.

At operation 304, one or more configurations for a merchant account are received, via the GUI. The merchant account is associated with a merchant.

In some examples, the one or more configurations for the merchant account include a processing time specific to the merchant that is associated with the merchant account. For example, some merchants may take one day to process (e.g., locate, create, move, package, transfer to a carrier, etc.) one or more products for a carrier to deliver, while other merchants may take two days, or three days, or four days, or any other number amount of time to process one or more products for a carrier to deliver. In some examples, the order processing time is how long a warehouse needs to process an order (e.g., in a number of business days). In some examples, the one or more configurations may include which days in a week are business days. In some examples, holidays are automatically excluded from business days and therefore add an extra day to how long is needed to process an order.

In some examples, the processing time is specific to the purchased one or more products. For example, a first product may have a first processing time that is less than the processing time of a second product. The first product and the second product may have different labels, stock keeping units (SKUs), sizes, colors, weights, or otherwise be differentiable from each other. Therefore, the one or more configurations may include entries and/or selections that correspond to processing times specific to particular products. In some examples, there may be a database or repository of processing times that are each associated with certain products, such that when a particular product is selected, a corresponding processing time associated with the merchant can be obtained.

In some examples, the one or more configurations for the merchant account comprise a selection between providing one of a single estimated delivery time or a range of estimated delivery times. For providing a range of estimated delivery times, a tolerance may be set as to how wide is the range. Some merchants may prefer to select a single estimated delivery time (e.g., a specific date or a time on a specific date). However, some merchants may prefer to provide a range of estimated delivery times (e.g., range of dates and/or times on dates), such as to improve user experience by reducing frustration of a customer in the event that the single time was incorrect.

In some examples, the one or more configurations for the merchant account include a preferred carrier and/or carrier service type. The preferred carrier may be any one of a plurality of carriers that may be recognize by those of ordinary skill in the art, such as companies or organizations that provide transportation for the movement of goods. Carrier service types may include air (e.g., airplanes, drones, etc.) water (e.g., ships, water skis, boats, etc.) ground (e.g., trucks, cars, trains, bicycle, etc.). Additional and/or alternative carrier service types or examples thereof will be recognized by those of ordinary skill in the art.

Receiving configurations for a merchant account is advantageous to enable mechanisms provided herein to provide accurate delivery estimates, such as for customers, carriers, distributors, or others. Further, collecting configurations for merchant accounts can be useful for aggregating data to calculate processing time metrics at scale (e.g., as may be beneficial for organizing inventory and/or warehouse logistics).

In some examples, the merchant account is configured based on the one or more configurations. Information associated with the merchant account may be stored local to a computing device (e.g., computing device 102) and/or remote from a computing device (e.g., on server 104). Accordingly, the configuring of the merchant account may include updating data stored in memory that is associated with the merchant account. When performing further processing, such as calculating a delivery time, the data stored in memory associated with the merchant account may be referenced by a processor to extract information applicable to the calculation of the delivery time.

At operation 308, parcel data is provided to a machine-learning model. The parcel data corresponds to one or more products purchased from the merchant. The one or more configurations and/or an indication thereof may also be provided to the machine-learning model. The machine-learning model may be trained based on historical parcel data, historical configurations, and historical delivery times to predict an estimated delivery time of one or more products.

The parcel data may be similar and/or the same as the parcel data 110 discussed earlier herein with respect to FIG. 1. For example, the parcel data may include a tracking number and/or information receivable from a tracking number. In some examples, the parcel data includes a carrier-provided delivery estimate, a carrier processing/handling time, a carrier name, a carrier service type (e.g., air, ground, expedited, normal, etc.), a tracking history, a status update, a current location, an origination location, a delivery location, one or more checkpoint locations, etc. In some examples, the parcel data includes an identifier of one or more products, a merchant from which the one or more products were ordered, a weight of the one or more products, etc. Additional and/or alternatives attributes of parcel data may be recognized by those of ordinary skill in the art, at least in light of teachings provided herein.

The historical parcel data, configurations, and delivery times may be aggregated from data collected by carriers and/or merchants. For example, the historical parcel data, configurations, and/or delivery times may be aggregated from calls to APIs and/or data stores associated with individual merchants/carriers. In some examples, the historical parcel data and delivery times may be aggregated from more than 1,300 carriers in different countries around the world. In some examples, the historical parcel data, configurations, and/or delivery times may be otherwise obtained and uploaded to a data store on which the machine-learning model may be trained.

The historical parcel data, configurations, and/or delivery times may be normalized, processed, and/or cleaned, as needed, to improve training of the machine-learning model. For example, mechanisms provided herein may include address parsers that can parse an address from text to structured data. Further, mechanisms provided herein may include auto-detect which can recognize carriers according to tracking numbers. With these functionalities, mechanisms provided herein may be able to provide-high-quality training data, which helps to improve performance of machine-learning models trained thereon.

In some examples, data attributes that are used to train the machine-learning model may include the name of a carrier, the type of service used by the carrier (e.g., air, ground, expedited, water), whether the origin and destination of the one or more products beings delivered belong to the same country, whether the origin and destination of the one or more products being delivered belong to the same state, whether the origin and destination of the one or more products being delivered belong to the same city, the raw address of the origin of the one or more products, the raw address of the destination of the one or more products, the weekday of the one or more package's pickup time, the time of day of the one or more package's pickup time, the sequence of holidays of the origin on the pickup day and the next 7 days, the raw address at a checkpoint of the one or more products while in transit, a message associated with the checkpoint, the number of days between pickup time and checkpoint time, and a number of checkpoints. In some examples, the raw addresses (e.g., of origins, destinations) may be converted to coordinates (e.g., including latitude and longitude).

In some examples, the machine-learning model includes one or more neural networks. In some examples, the machine-learning model includes one or more deep learning models that are trained using deep learning techniques to improve accuracy of predictions. In some examples, the machine-learning model includes one or more regressive neural networks (RNNs) and/or one or more convolutional neural networks (CNNs).

In some examples, encoding methods are used to transform data inputs into real number vectors. The machine-learning model will learn the weights of the data inputs according to a distribution of the data inputs, automatically.

At operation 310, an estimated delivery time of the one or more products purchased from the merchant is received from the machine-learning model. The estimated delivery time may be provided as an output. Additionally, or alternatively, an indication of the estimated delivery time may be generated for insertion into a virtual page (e.g., a web page, a mobile application page, a desktop application page). In some examples, a widget is generated that includes the indication of the estimated delivery time and the widget is inserted into the virtual page.

In some examples, a message is generated that includes the estimated delivery time or an indication thereof. The message may be sent (e.g., via email, message, telephone, notification, etc.). The message may be sent to a customer, such as a customer who purchased the one or more products being delivered. Additionally, or alternatively, the message may be sent to a warehouse, or another entity with an interest in the delivery of the one or more products.

At operation 312, it is determined if one or more factors influencing the estimated delivery time changed. For example, updated parcel data may be received from a carrier service and/or provided by a user. The updated parcel data may correspond to a checkpoint of a parcel while it is in transit to its destination. It may be determined if there is updated parcel data by polling an application programming interface (API) associated with a carrier service and/or by determining if a checkpoint exists for the one or more products in transit.

The updated parcel data may include a message of a checkpoint corresponding to a parcel being on time or delayed. For example, the checkpoint message may include: “currently awaiting shipment and tracking will be updated when received,” or “experiencing delay due to inclement weather, tracking will be updated when in transit.” Checkpoint messages may indicate that a parcel containing the one or more packages is on-time, delayed, or that the current status of the parcel is unknown but that an update will be provided shortly. In some examples, parcels may be delayed due to holidays, power-outages, inclement weather, protests, traffic, pandemics, floods, gas leaks, customs clearance, or other circumstances which those of ordinary skill in the art will recognize may delay the delivery of parcels. In some instances, the checkpoint messages may indicate for how long a parcel is delayed. In some instances, mechanisms provided herein may product for how long the parcel is delayed based on the checkpoint message that is provided and historical parcel data on which the machine-learning model is trained.

Generally, sources of information containing up-to-date information corresponding to data inputs on which the machine-learning model has been trained may be polled, scraped, or otherwise checked to determine whether an input used to calculate the estimated delivery time has changed. In some examples, the change is compared to a threshold to determine whether the change is significant enough to advance to operation 316 or whether instead to advance to operation 314.

If it is determined that one or more factors influencing the delivery time have not changed, then flow branches “NO” to operation 314, where a default action is performed. For example, the estimated delivery time may include a pre-configured action that is performed at operation 314. In some examples, method 300 may comprise determining whether the estimated delivery time has an associated default action, such that, in some instances, no action may be performed as a result of determining that no factors influencing the estimated delivery time have changed. Method 300 may terminate at operation 314. Alternatively, method 300 may return to operation 302 to provide an iterative loop of configuring a merchant account, calculating an estimated delivery time of one or more products, and determining whether any factors influencing the estimated delivery time have changed.

However, if it is determined that one or more factors influencing the estimated delivery time have changed, then flow branches “YES”, wherein method 300 advances to operation 316. At operation 316, the estimated delivery time of the one or more products is dynamically updated. The estimated delivery time may be dynamically updated while the one or more products are in transit (e.g., after the one or more products have already left their origin, but before they have arrived at their destination).

The estimated delivery time may be dynamically updated by providing information corresponding to the one or more factors to a machine-learning model to predict an updated estimated delivery time of the one or more products. The information corresponding to the one or more factors may be weather data, or news alerts, or user-provided information, or merchant-provided information, or a change of delivery address, or a checkpoint message. Additional and/or alternative factors influencing the estimated delivery time may be recognized by those of ordinary skill in the art.

In some examples, the dynamically updated delivery time is returned. The dynamically updated estimated delivery time may be provided as an output. Additionally, or alternatively, an indication of the dynamically updated estimated delivery time may be generated for insertion into a virtual page (e.g., a web page, a mobile application page, a desktop application page). In some examples, a widget is generated that includes the indication of the dynamically updated estimated delivery time and the widget is inserted into the virtual page. In some examples, the dynamically updated estimated delivery time (or an indication thereof) replaces the estimated delivery time (or an indication thereof) on the virtual page.

In some examples, a message is generated that includes the dynamically updated estimated delivery time or an indication thereof. The message may be sent (e.g., via email, message, telephone, notification, etc.). The message may be sent to a customer, such as a customer who purchased the one or more products being delivered. Additionally, or alternatively, the message may be sent to a warehouse, or another entity with an interest in the delivery of the one or more products.

Generally, dynamically updating the estimated delivery time provides the ability to alter the delivery time of one or more products (e.g., while they are in transit), based on up-to-date information, thus enabling accuracy in predicting the delivery time of the one or more products. Information related to factors influencing the estimated delivery time may be extracted from checkpoint messages, received from customers, received from merchants, received from news, weather, messages, press releases, or other sources of information that may be recognized by those of ordinary skill in the art.

Method 300 may terminate at operation 316. Alternatively, method 300 may return to operation 302 (or any other operation from method 300) to provide an iterative loop, such as of configuring a merchant account, calculating an estimated delivery time based on the configurations of the merchant account and parcel data, and dynamically updating the estimated delivery time based on altered factors influencing the estimated delivery time.

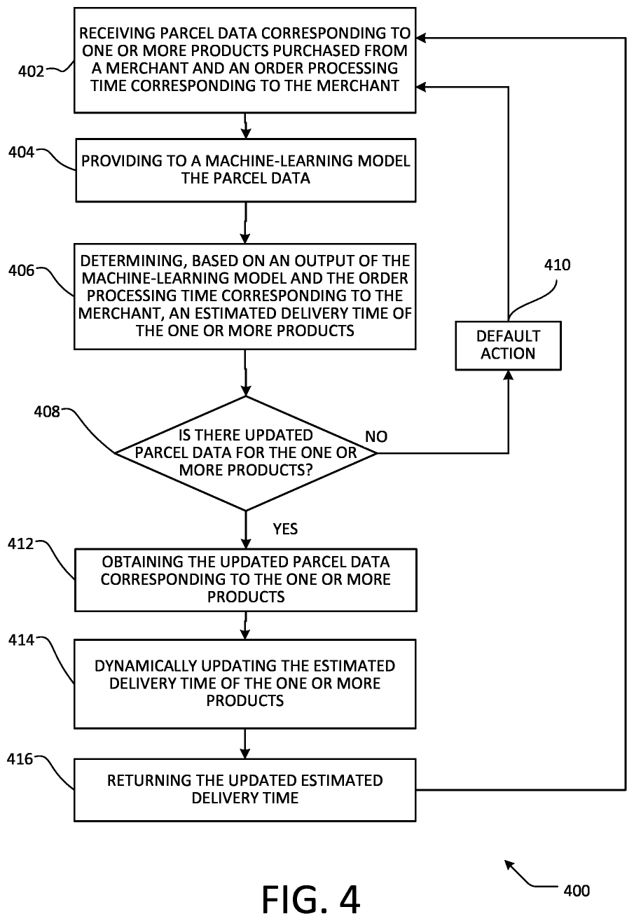

FIG. 4 illustrate an example method 400, according to some aspects described herein. The example method 400 may be a method for predicting a delivery time. In examples, aspects of method 400 are performed by a device, such as computing device 102 and/or server 104, discussed above with respect to FIG. 1.

Method 400 begins at operation 402, wherein parcel data is received that corresponds to one or more products purchased from a merchant. Also at operation 402, an order processing time corresponding to the merchant is received. The order processing time may be a configuration of a merchant account associated with the merchant, such as discussed earlier herein with respect to methods 200 and 300.

In some examples, the processing time is specific to the purchased one or more products. For example, a first product may have a first processing time that is less than the processing time of a second product. The first product and the second product may have different labels, stock keeping units (SKUs), sizes, colors, weights, or otherwise be differentiable from each other. Therefore, the one or more configurations may include entries and/or selections that correspond to processing times specific to particular products. In some examples, there may be a database or repository of processing times that are each associated with certain products, such that when a particular product is selected, a corresponding processing time associated with the merchant can be obtained.

Receiving an order processing time specific to a merchant is advantageous to enable mechanisms provided herein to provide accurate delivery estimates, such as for customers, carriers, distributors, or others. Further, collecting order processing times from merchants can be useful for aggregating data to calculate processing time metrics at scale (e.g., as may be beneficial for organizing inventory and/or warehouse logistics).

The parcel data received at operation 402 may be similar and/or the same as the parcel data 110 discussed earlier herein with respect to FIG. 1. For example, the parcel data may include a tracking number and/or information receivable from a tracking number. In some examples, the parcel data includes a carrier-provided delivery estimate, a carrier processing/handling time, a carrier name, a carrier service type (e.g., air, ground, expedited, normal, etc.), a tracking history, a status update, a current location, an origination location, a delivery location, one or more checkpoint locations, etc. In some examples, the parcel data includes an identifier of the one or more products, a merchant from which the one or more products were ordered, a weight of the one or more products, etc. Additional and/or alternatives attributes of parcel data may be recognized by those of ordinary skill in the art, at least in light of teachings provided herein.

At operation 404, the parcel data is provided to a machine-learning model. The machine-learning model is trained based on historical parcel data and/or historical delivery times to predict an estimated delivery time of one or more products. The historical parcel data and/or delivery times may be aggregated from data collected by carriers and/or merchants. For example, the historical parcel data and/or delivery times may be aggregated from calls to APIs and/or data stores associated with individual merchants/carriers. In some examples, the historical parcel data and delivery times may be aggregated from more than 1,300 carriers in different countries around the world. In some examples, the historical parcel data and/or delivery times may be otherwise obtained and uploaded to a data store on which the machine-learning model may be trained.

The historical parcel data and/or delivery times may be normalized, processed, and/or cleaned, as needed, to improve training of the machine-learning model. For example, mechanisms provided herein may include address parsers that can parse an address from text to structured data. Further, mechanisms provided herein may include auto-detect which can recognize carriers according to tracking numbers. With these functionalities, mechanisms provided herein may be able to provide-high-quality training data, which helps to improve performance of machine-learning models trained thereon.

In some examples, data attributes that are used to train the machine-learning model may include the name of a carrier, the type of service used by the carrier (e.g., air, ground, expedited, water), whether the origin and destination of the one or more products beings delivered belong to the same country, whether the origin and destination of the one or more products being delivered belong to the same state, whether the origin and destination of the one or more products being delivered belong to the same city, the raw address of the origin of the one or more products, the raw address of the destination of the one or more products, the weekday of the one or more package's pickup time, the time of day of the one or more package's pickup time, the sequence of holidays of the origin on the pickup day and the next 7 days, the raw address at a checkpoint of the one or more products while in transit, a message associated with the checkpoint, the number of days between pickup time and checkpoint time, and a number of checkpoints. In some examples, the raw addresses (e.g., of origins, destinations) may be converted to coordinates (e.g., including latitude and longitude).

In some examples, the machine-learning model includes one or more neural networks. In some examples, the machine-learning model includes one or more deep learning models that are trained using deep learning techniques to improve accuracy of predictions. In some examples, the machine-learning model includes one or more regressive neural networks (RNNs) and/or one or more convolutional neural networks (CNNs).

In some examples, encoding methods are used to transform data inputs into real number vectors. The machine-learning model may learn the weights of the data inputs according to a distribution of the data inputs, automatically.

At operation 406, based on an output of the machine-learning model and the order processing time that corresponds to the merchant, an estimated delivery time of the one or more products is determined. The determination may be a calculation. For example, the order processing time may be added to a delivery time output by the machine-learning model. Additional and/or alternative arithmetic relationships may be recognized by those of ordinary skill in the art to calculate the estimated delivery time based on the order processing time corresponding to the merchant and the output of the machine-learning model.

In some examples, the estimated delivery time may be provided as an output. Additionally, or alternatively, an indication of the estimated delivery time may be generated for insertion into a virtual page (e.g., a web page, a mobile application page, a desktop application page). In some examples, a widget is generated that includes the indication of the estimated delivery time and the widget is inserted into the virtual page.

In some examples, a message is generated that includes the estimated delivery time or an indication thereof. The message may be sent (e.g., via email, message, telephone, notification, etc.). The message may be sent to a customer, such as a customer who purchased the one or more products being delivered. Additionally, or alternatively, the message may be sent to a warehouse, or another entity with an interest in the delivery of the one or more products.

At operation 408, it is determined if there is updated parcel data for the one or more products. For example, updated parcel data may be received from a carrier service and/or provided by a user. The updated parcel data may correspond to a checkpoint of a parcel while it is in transit to its destination. It may be determined if there is updated parcel data by polling an application programming interface (API) associated with a carrier service and/or by determining if a checkpoint exists for the one or more products in transit.

If there is not updated parcel data for the one or more products, then flow branches “NO” to operation 410, where a default action is performed. For example, the estimated delivery time may include a pre-configured action that is performed at operation 410. In some examples, method 400 may comprise determining whether the estimated delivery time has an associated default action, such that, in some instances, no action may be performed as a result of determining that no updated parcel data has been received. Method 400 may terminate at operation 410. Alternatively, method 400 may return to operation 402 to provide an iterative loop of receiving parcel data and an order processing time associated with a merchant, calculating an estimated delivery time of one or more products that correspond to the parcel data, and determining whether updated parcel data for the one or more products is obtainable.

However, if it is determined that there is updated parcel data for the one or more products, then flow branches “YES”, wherein method 400 advances to operation 412. At operation 412, the updated parcel data is obtained. The updated parcel data may have similar attributes as discussed with respect to the parcel data of operation 402. The updated parcel data may be obtained while the one or more products are in transit to be delivered (e.g., after the one or more products have already left their origin, but before they have arrived at their destination). The updated parcel data corresponds to the one or more products (e.g., one or more parcels containing the one or more products).

The updated parcel data may include a message of a checkpoint corresponding to a parcel being on time or delayed. For example, the checkpoint message may include: “currently awaiting shipment and tracking will be updated when received,” or “experiencing delay due to inclement weather, tracking will be updated when in transit.” Checkpoint messages may indicate that a parcel containing the one or more packages is on-time, delayed, or that the current status of the parcel is unknown but that an update will be provided shortly. In some examples, parcels may be delayed due to holidays, power-outages, inclement weather, protests, traffic, pandemics, floods, gas leaks, customs clearance, or other circumstances which those of ordinary skill in the art will recognize may delay the delivery of parcels. In some instances, the checkpoint messages may indicate for how long a parcel is delayed. In some instances, mechanisms provided herein may product for how long the parcel is delayed based on the checkpoint message that is provided and historical parcel data on which the machine-learning model is trained.

At operation 414, the estimated delivery time of the one or more products is dynamically updated. In some examples, the estimated delivery time of the one or more products is dynamically updated while the one or more products are in transit (e.g., after the one or more products have left an origin location, but before they have arrived at a destination location). In some examples, the estimated delivery time is dynamically updated by providing the updated parcel data to the machine-learning model to predict an updated estimated delivery time of the one or more products. For example, the updated estimated delivery time may be determined by the machine-learning model based on (and/or at least in part on) the updated parcel data. In some examples, the estimated delivery time may be otherwise dynamically updated, based on the updated parcel data, such as via one or more linear equations and/or one or more non-linear equations.

At operation 416, the updated estimated delivery time is returned. The updated estimated delivery time may be provided as an output. Additionally, or alternatively, an indication of the updated estimated delivery time may be generated for insertion into a virtual page (e.g., a web page, a mobile application page, a desktop application page). In some examples, a widget is generated that includes the indication of the updated estimated delivery time and the widget is inserted into the virtual page. In some examples, the updated estimated delivery time (or an indication thereof) replaces the estimated delivery time (or an indication thereof) on the virtual page.

In some examples, a message is generated that includes the updated estimated delivery time or an indication thereof. The message may be sent (e.g., via email, message, telephone, notification, etc.). The message may be sent to a customer, such as a customer who purchased the one or more products being delivered. Additionally, or alternatively, the message may be sent to a warehouse, or another entity with an interest in the delivery of the one or more products.

Generally, updating the estimated delivery time provides the ability to dynamically alter the delivery time of one or more products (e.g., while they are in transit), based on up-to-date information, thus enabling accuracy in predicting the delivery time of the one or more products. Indications of events that lead to the dynamic updating may be extracted automatically from checkpoint messages and real-time locations of the one or more products.

Method 400 may terminate at operation 416. Alternatively, method 400 may return to operation 402 (or any other operation from method 400) to provide an iterative loop, such as of receiving parcel data and a merchant processing time (both corresponding to one or more products), calculating an estimated delivery time of the one or more products, and dynamically updating the estimated delivery time based on updated parcel data.

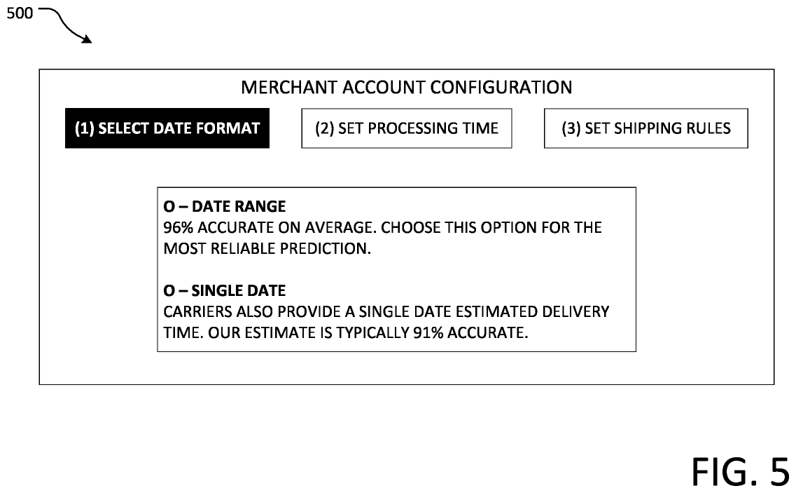

FIG. 5 illustrates an example user-interface 500, according to some aspects provided herein. The example user-interface 500 is a graphical user-interface (GUI). The GUI 500 may receive inputs to configure a merchant account (e.g., as discussed earlier herein with respect to operation 202 of FIG. 2 and operation 304 of FIG. 3). It should be recognized that user-interface 500 is merely an example.

The GUI 500 includes a plurality of indications that each comprise a respective step for configuring the merchant account. In FIG. 5, a first indication, labelled “SELECT DATE FORMAT” is provided to indicate to a user (e.g., an agent acting on behalf of a merchant) that on the current step they are supposed to select a date format. In some examples, a plurality of date format options are provided for estimated a delivery time.

A first date format may be a date range, such that a range of dates may be provided during which one or more products are estimated to be delivered. In some examples, the range of dates may instead be a range of times (e.g., on one day or across two or more days). A second date format may be a single date, such that a single date may be provided on which one or more products are estimated to be delivered. In some examples, the single date may instead be a single time (e.g., on one day).

Generally, the date range format may be more accurate than the single date format. Further, a user may configure a tolerance for how many days are to be included in the date range and/or how accurate the user wants the date range to be (e.g., thereby including as many days in the range as needed to have the requisite accuracy). Such custom date format configurations allow a merchant to receive/provide accurate estimated delivery times.

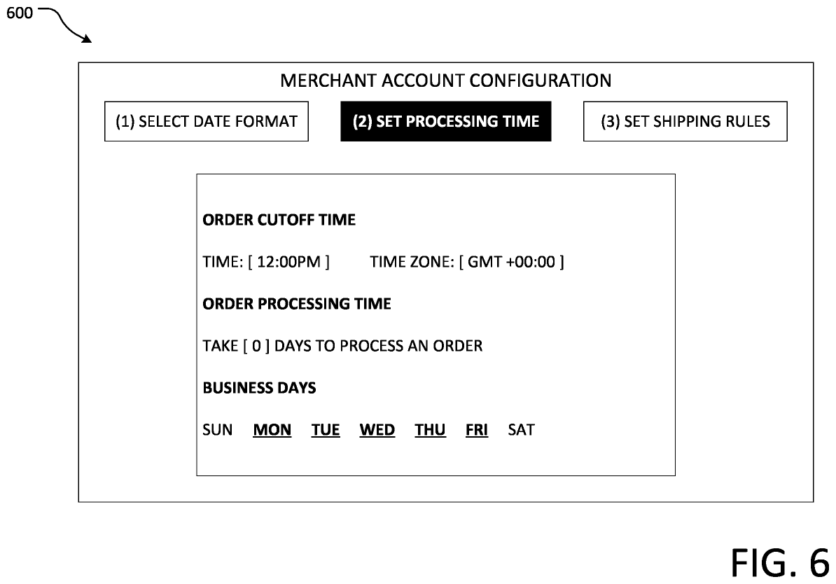

FIG. 6 illustrates an example user-interface 600, according to some aspects provided herein. The example user-interface 600 is a graphical user-interface (GUI). The GUI 600 may receive inputs to configure a merchant account (e.g., as discussed earlier herein with respect to operation 202 of FIG. 2 and operation 304 of FIG. 3). It should be recognized that user-interface 500 is merely an example. Further, it should be recognized that GUIs 500 and 600 may be part of a single user-interface that transitions between the GUI 500 and the GUI 600 (e.g., using one or more animations).

The GUI 600 includes a plurality of indications that each comprise a respective step for configuring the merchant account. In FIG. 6, a second indication, labelled “SET PROCESSING TIME” is provided to indicate to a user (e.g., an agent acting on behalf of a merchant) that on the current step they are supposed to set a processing time for their orders.

The configurations for the processing time may include setting a cutoff time for when an order can be processed on a given day (e.g., until the order will not be processed until a subsequent day). The order cutoff time may include a time of day, as well as a time zone in which the time of day is specified. The configurations for the processing time may further include a number of days that it takes to process an order. For example, the number of days may be 0 days, or 1 day, or 5 days, or 14 days, etc. In some examples, the number of days may instead be a number of hours, or weeks, or another unit of time.

The configurations for the processing time may include selecting which days of a week or business days. For example, business days may include Monday, Tuesday, Wednesday, Thursday, and Friday. In some examples, business days may additionally and/or alternatively, include one or more selected from the group of Sunday and Saturday. In some examples, holidays may be automatically excluded from business days. In some examples, a user may select which holidays are excluded from business days (if any) and which holidays are still considered to be business days (if any).

Generally, setting a processing time for orders that is customized to a merchant allow the merchant to receive/provide accurate estimated delivery times.

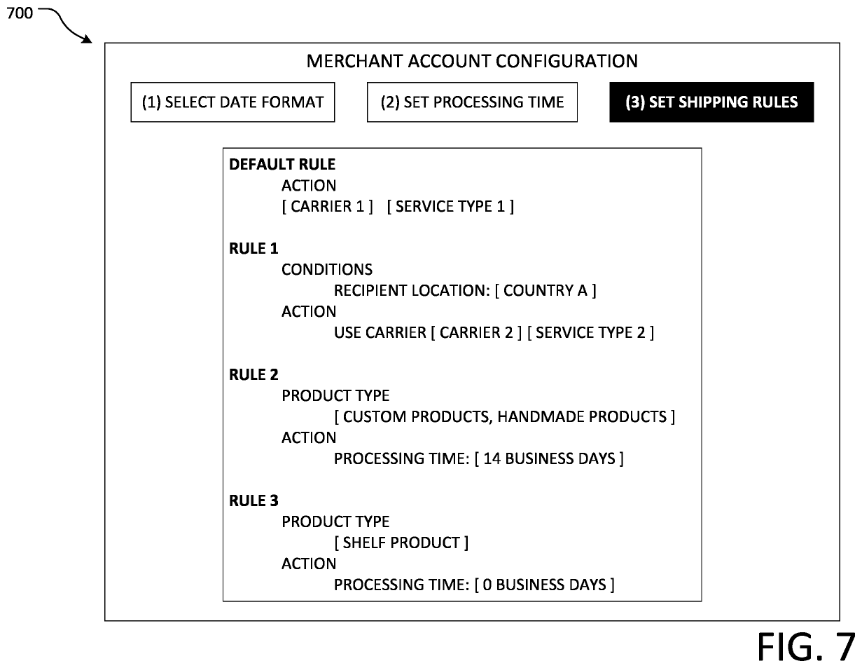

FIG. 7 illustrates an example user-interface 700, according to some aspects provided herein. The example user-interface 700 is a graphical user-interface (GUI). The GUI 700 may receive inputs to configure a merchant account (e.g., as discussed earlier herein with respect to operation 202 of FIG. 2 and operation 304 of FIG. 3). It should be recognized that user-interface 700 is merely an example. Further, it should be recognized that GUIs 500, 600, and/or 700 may be part of a single user-interface that transitions between the GUIs 500, 600, and/or 700 (e.g., using one or more animations).

The GUI 700 includes a plurality of indications that each comprise a respective step for configuring the merchant account. In FIG. 6, a third indication, labelled “SET SHIPPING RULES” is provided to indicate to a user (e.g., an agent acting on behalf of a merchant) that on the current step they are supposed to set shipping rules for orders.

The configurations for the shipping rules may include a default rule. For example, a merchant may have a preferred carrier and/or a preferred service type. The merchant may enter the preferred carrier and/or preferred service type under the default rule. Carrier service types may include air (e.g., airplanes, drones, etc.), water (e.g., ships, water skis, boats, etc.), ground (e.g., trucks, cars, trains, bicycle, etc.), etc. The carrier service types may additionally and/or alternatively include priority levels, such as “expedited,” “priority,” “same day,” “two-day,” or other priority levels that may be recognized by those of ordinary skill in the art.

The configurations for the shipping rules may include one or more rules (e.g., in addition to the default rule). For example, shipping rules may be provided based on certain conditions and/or product types. As an example, one condition may be a recipient's location. If the recipient is located in a specific country, such as Country A, then a specific carrier and/or carrier type may be used based on the recipient's location.

As another example, one condition may be a type of product. For example, if a product is a custom product and/or a handmade product, then a processing time may be relatively larger than if a product is not a custom product and/or a handmade product, such as a product that is already on a shelf (e.g., in a store, warehouse, etc.). Accordingly, processing times may be paired with certain types of products (e.g., custom products, handmade products, shelf products, etc.). In some examples, processing times may be paired with products based on the products labels, SKUs, sizes, colors, weights, materials, popularity, or other characteristics that may be recognized by those of ordinary skill in the art.

An additional and/or alternative rules that may be set include setting a carrier pickup date (e.g., a specific calendar date and/or day of the week) based on one or more products. The set carrier pickup date may be for all products or for certain products (e.g., based on one or more of the product characteristics discussed above). Another additional and/or alternative rule that may be set includes setting a carrier pickup date based on a recipients location (e.g., a city, state, country, address, or the like at which a recipient is located).

In some examples, shipping rules can have multiple conditions. For example, if a product type is “electronic” and the destination country is Country A, then a first carrier and a first service type may be used. Comparatively, if a product is “handmade” and the destination country is Country A, then the first carrier and a second service type may be used. Additional and/or alternative combinations of product, recipient locations, pickup dates, processing times, carriers, and/or service types will be recognized by those of ordinary skill in the art.

Generally, setting shipping rules that are customized to a merchant allow the merchant to receive/provide accurate estimated delivery times.

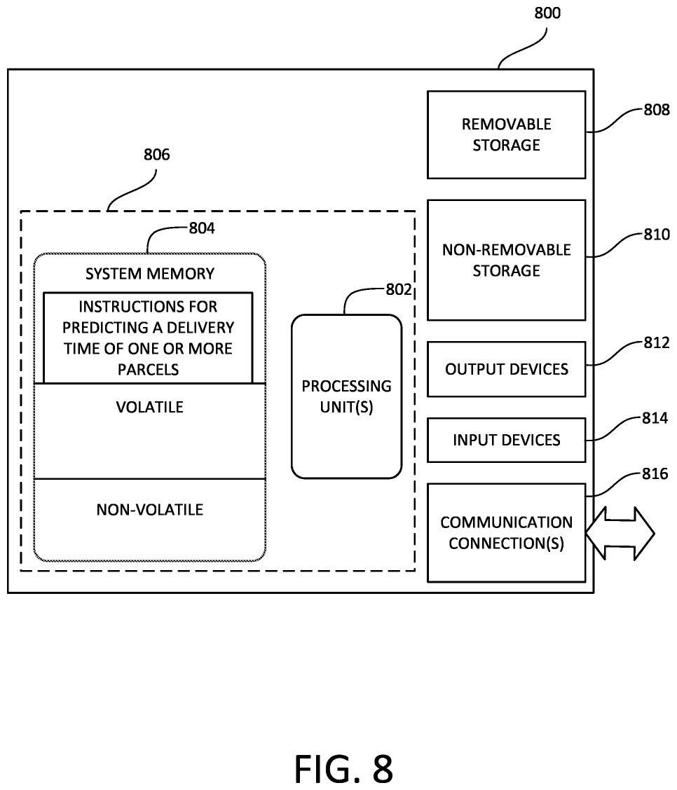

FIG. 8 illustrates a simplified block diagram of a device with which aspects of the present disclosure may be practiced in accordance with aspects of the present disclosure. The device may be a mobile computing device, for example. One or more of the present embodiments may be implemented in an operating environment 800. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 800 typically includes at least one processing unit 802 and memory 804. Depending on the exact configuration and type of computing device, memory 804 (e.g., instructions for one or more aspects disclosed herein, such as one or more aspects of methods/processes 200, 300, and/or 400, described with respect to FIGS. 2, 3, and 4, respectively) may be volatile (such as RAM), non-volatile (such as ROM, flash memory, etc.), or some combination of the two. This most basic configuration is illustrated in FIG. 8 by dashed line 806. Further, the operating environment 800 may also include storage devices (removable, 808, and/or non-removable, 810) including, but not limited to, magnetic or optical disks or tape. Similarly, the operating environment 800 may also have input device(s) 814 such as remote controller, keyboard, mouse, pen, voice input, on-board sensors, etc. and/or output device(s) 812 such as a display, speakers, printer, motors, etc. Also included in the environment may be one or more communication connections 816, such as LAN, WAN, a near-field communications network, a cellular broadband network, point to point, etc.

Operating environment 800 typically includes at least some form of computer readable media. Computer readable media can be any available media that can be accessed by the at least one processing unit 802 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 800 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method for predicting a delivery time, the method comprising:
receiving one or more configurations for a merchant account associated with a merchant, wherein the one or more configurations for the merchant account comprise one or more shipping rules specific to the merchant associated with the merchant account;
providing to a machine-learning model parcel data corresponding to one or more products purchased from the merchant and the one or more configurations, wherein the machine-learning model is trained based on historical parcel data, configurations, and delivery times to predict an estimated delivery time of one or more products;
receiving from the machine-learning model an estimated delivery time of the one or more products purchased from the merchant;
obtaining updated parcel data corresponding to the one or more products;
providing to the machine-learning model the updated parcel data to receive an updated estimated delivery time;
generating an indication of the updated estimated delivery time for insertion into a virtual page viewable by a user; and
inserting the indication of the updated estimated delivery time into the virtual page, to improve accuracy of delivery time information provided to the user, in real time.

2. (canceled)

3. The method of claim 1, wherein the virtual page is one of a web page, a mobile application page, or a desktop application page.

4. The method of claim 3, wherein the generating comprises generating a widget comprising the indication of the updated estimated delivery time, and wherein the widget comprising the indication is inserted into the virtual page.

5. The method of claim 1, wherein the one or more configurations for the merchant account further comprise a processing time specific to the merchant associated with merchant account.

6. The method of claim 1, wherein the processing time is specific to the purchased one or more products.

7. The method of claim 1, wherein the one or more configurations for the merchant account comprise a selection between providing one of a single estimated delivery time or a range of estimated delivery times.

8. The method of claim 1, wherein the one or more configurations for the merchant account comprise a preferred carrier and carrier service type.

9. The method of claim 1, further comprising:
generating a graphical user-interface (GUI); and
receiving, via the GUI, the one or more configurations for the merchant account.

10. The method of claim 1, further comprising:
generating a message comprising the estimated delivery time; and
sending the message.

11. The method of claim 1, wherein the machine-learning model comprises one or more neural networks.

12. A system comprising:
a processor; and
memory storing instructions that, when executed by the processor, cause the system to perform a set of operations, the set of operations comprising:
generating a graphical user-interface (GUI);
receiving, via the GUI, one or more configurations for a merchant account associated with a merchant, wherein the one or more configurations for the merchant account comprise one or more shipping rules specific to the merchant associated with the merchant account;
providing to a machine-learning model parcel data corresponding to one or more products purchased from the merchant and the one or more configurations, wherein the machine-learning model is trained based on historical parcel data, configurations, and delivery times to predict an estimated delivery time of one or more products;
receiving from the machine-learning model an estimated delivery time of the one or more products purchased from the merchant;
dynamically updating the estimated delivery time of the one or more products;
generating an indication of the updated estimated delivery time for insertion into a virtual page viewable by a user; and
inserting the indication of the updated estimated delivery time into the virtual page, to improve accuracy of delivery time information provided to the user, in real time.

13. (canceled)

14. The system of claim 12, wherein the virtual page is one of a web page, a mobile application page, or a desktop application page.

15. The system of claim 12, wherein the one or more configurations for the merchant account further comprise a processing time specific to the merchant associated with merchant account.

16. The system of claim 12, wherein the processing time is specific to the purchased one or more products.

17. The system of claim 12, wherein the one or more configurations for the merchant account comprise a preferred carrier and carrier service type.

18. A method for predicting a delivery time, the method comprising:
receiving parcel data corresponding to one or more products purchased from a merchant, one or more shipping rules corresponding to the merchant, and an order processing time corresponding to the merchant;
providing to a machine-learning model the parcel data, wherein the machine-learning model is trained based on historical parcel data and delivery times to predict an estimated delivery time of one or more products;
determining, based on an output of the machine-learning model and the order processing time corresponding to the merchant, an estimated delivery time of the one or more products purchased from the merchant;
obtaining updated parcel data corresponding to the one or more products;
dynamically updating the estimated delivery time of the one or more products, thereby generating an updated estimated delivery time;
generating an indication of the updated estimated delivery time for insertion into a virtual page viewable by a user; and
inserting the indication of the updated estimated delivery time into the virtual page, to improve accuracy of delivery time information provided to the user, in real time.

19. The method of claim 18, wherein the machine-learning model comprises one or more neural networks.

20. (canceled)

21. The method of claim 1, wherein the merchant account is a first merchant account corresponding to a first merchant, and wherein the method further comprising receiving one or more configurations for a second merchant account associated with a second merchant.

22. The method of claim 21, wherein the one or more shipping rules specific to the first merchant comprise at least one of a preferred carrier or preferred service type of the first merchant.

23. The method of claim 1, wherein the obtaining updated parcel data corresponding to the one or more products includes:
polling, over a network and via a processor remote from memory storing the updated parcel data, an application programming interface associated with the updated parcel data; and
extracting, over the network, the updated parcel data.
